(19) United States
(12) Patent Application Publication
(10) Pub. No.: US 2026/0177116 A1
(43) Pub. Date: Jun. 25, 2026

(54) BRAKE DISCS AND METHODS FOR MANUFACTURING BRAKE DISCS

(71) Applicant: Transportation IP Holdings, LLC, Norwalk, CT (US)

(72) Inventors: Jayathirtha SRIPATHAN, Bangalore, Karnataka (IN); E. DICKSON, Tamil Nadu (IN); Balaji Hosadurgam RAVINDRANATH, Mysore, Karnataka (IN); Gireesha Dhani RANGANATHA, Karnataka (IN); Girish Mandya GANGHADHAR, Bangalore, Karnataka (IN); Madduluri VENKATADRI, Telangana (IN); Nirmalya MISHRA, Bangalore, Karnataka (IN); Sandeep KUMAR, Bangalore, Karnataka (IN)

(73) Assignee: Transportation IP Holdings, LLC, Norwalk, CT (US)

(21) Appl. No.: 19/127,952

(22) PCT Filed: Nov. 6, 2023
(86) PCT No.: PCT/US2023/078806

§ 371 Date: May 7, 2025

Related U.S. Application Data
(60) Provisional application No. 63/382,615, filed on Nov. 7, 2022.

(51) Int. Cl. F16D 65/12; B23K 9/04; B23K 10/02; C22C 19/05; C22C 19/07; C22C 38/02; C22C 38/04; C22C 38/44; F16D 65/02; F16D 69/02

(52) U.S. Cl. CPC F16D 65/127; C22C 19/058; C22C 19/07; C22C 38/02; C22C 38/04; C22C 38/44; F16D 69/027; B23K 9/04; B23K 10/02; F16D 65/124; F16D 65/125; F16D 2065/132; F16D 2200/0013; F16D 2200/0021; F16D 2200/0026; F16D 2250/0046

(57) ABSTRACT

A brake disc includes a brake disc body having a side surface and a hardfacing layer deposited onto the side surface of the brake disc body. The brake disc body is formed of a first material having a first hardness. The hardfacing layer is formed of a second material having a second hardness. The second hardness is greater than the first hardness. The hardfacing layer defines an externally oriented surface of the brake disc that is configured to be contacted by a brake pad for a vehicle braking operation.

### CROSS-REFERENCE TO RELATED APPLICATION

This application claims priority to U.S. Provisional Ser. No. 63/382,615 , filed 7 Nov. 2022, the disclosure of which is hereby incorporated by reference herein in its entirety.

### BACKGROUND

### Technical Field

Aspects of the present disclosure relate to vehicle braking systems. Other aspects relate to mechanical components of vehicle braking systems, and methods for manufacturing braking system components.

### Discussion of Art

Some vehicle braking systems include brake discs. A brake disc is attached to a rotating component of a vehicle. In operation, a brake pad is pressed against a surface of the disc to slow the speeds of the vehicle wheels. For example, in a locomotive or other rail vehicle, an annular disc may be attached to the side of a wheel, or attached to an axle that supports two wheels. In either case, the disc rotates along with the wheel or axle. A brake actuator, associated with a brake caliper and brake pad attached to the caliper, is attached to the vehicle body proximate to the disc. In operation, for slowing the speeds of the rail vehicle wheels, activating the brake actuator causes the caliper to move the brake pad against an annular, smooth, side surface of the brake disc. Frictional interaction between the pad and disc causes the disc, and thereby the wheel or axle, and ultimately the vehicle, speed to be reduced. The frictional interaction, however, causes the surface of the brake disc to wear out over time, requiring replacement or other maintenance. Replacing a brake disc on a rail vehicle is expensive, time consuming, and requires substantial vehicle down-time. The more often the brake disc needs to be replaced, therefore, the greater the overall cost to the vehicle operator.

Therefore, it may be desirable to provide brake discs and methods of manufacturing brake discs that differ from existing products and methods, and as a result reduce the frequency of associated required repair and maintenance.

### BRIEF DESCRIPTION

In one or more embodiments, a brake disc includes a brake disc body having a side surface and a hardfacing layer deposited onto the side surface of the brake disc body. The brake disc body is formed of a first material having a first hardness. The hardfacing layer is formed of a second material having a second hardness. The second hardness is greater than the first hardness. The hardfacing layer defines an externally oriented surface of the brake disc that is configured to be contacted by a brake pad for a vehicle braking operation.

In one or more embodiments, an assembly for a rail vehicle includes a first wheel, a second wheel, an axle coupled to the first wheel and the second wheel and extending therebetween, a brake disc mounted onto the first wheel, the second wheel, or the axle, and a braking assembly. The brake disc includes a brake disc body formed of a first material. The brake disc body has a side surface. The brake disc also includes a hardfacing layer deposited onto the side surface. The hardfacing layer defines an externally oriented surface of the brake disc. The braking assembly includes a brake pad coupled to an actuator. The actuator is configured to cause the brake pad to contact the externally oriented surface defined by the hardfacing layer during a braking operation.

In one or more embodiments, a method includes mounting a brake disc to a table spaced a predetermined distance from a hardfacing deposition apparatus. The brake disc is formed of a first material and has a side surface oriented away from the table toward the deposition apparatus. The method also includes depositing, using the deposition apparatus, a hardfacing layer onto the side surface of the brake disc. The hardfacing layer is formed of a second material having a hardness greater than the first material. The deposited hardfacing layer defines an externally oriented surface.

### BRIEF DESCRIPTION OF THE DRAWINGS

The inventive subject matter may be understood from reading the following description of non-limiting embodiments, with reference to the attached drawings, wherein below:

FIG. 1 is a schematic side cross-sectional view of an assembly for a rail vehicle that includes an embodiment of an axle-mounted brake disc and a braking assembly;

FIG. 2 is a schematic side cross-sectional view of another assembly for a rail vehicle that includes an embodiment of a wheel-mounted brake disc;

FIG. 3 is a magnified, schematic side cross-sectional view of the axle-mounted brake disc shown in FIG. 1 or the wheel-mounted brake disc shown in FIG. 2 along with a portion of a braking assembly;

FIG. 4 is a schematic side view of an embodiment of a unitary brake disc;

FIG. 5 is a schematic side view of an embodiment of a segmented brake disc, having four equally-sized segments in this example;

FIG. 6 is an example flow chart illustrating a method according to an embodiment of the present disclosure;

FIG. 7 is a schematic illustration of an example plasma transferred arc apparatus that may be used to perform the method shown in FIG. 6; and

FIG. 8 is a schematic illustration of an example arc welding machine that may be used to perform the method shown in FIG. 6.

Corresponding reference numerals used throughout the drawings indicate corresponding parts.

### DETAILED DESCRIPTION

Embodiments of the subject matter described herein relate to vehicle braking systems, and, in particular, to brake discs for rail vehicles and other vehicles. A brake disc may generally refer to a structure configured to be mounted on a rotating member of a vehicle, such as a rail vehicle, for example. A rotating member may be any wheel structure, including a rail vehicle wheel, or may be a load-bearing component of the vehicle configured to facilitate or cause rotation of the wheel structure via rotational force, such as an axle shaft (or “axle”). The brake disc may be wheel mounted, axle mounted, or flange mounted. The brake disc is configured to be contacted by a braking mechanism, such as a brake jaw, brake pad, or brake shoe for a vehicle braking operation. Friction between the brake disc and the braking mechanism inhibits, slows, or otherwise facilitates decreasing rotational speed of the rotating member. In one embodiment, a brake disc is provided that includes a body having a side surface and a hardfacing layer deposited onto the side surface. The hardfacing layer defines an externally oriented surface of the brake disc that is configured to be contacted by a braking mechanism for a vehicle braking operation. Suitably, the hardfacing layer has a hardness that is greater than a hardness of the brake disc body. Accordingly, the hardfacing layer may facilitate increasing a wear resistance of the brake disc relative to brake discs that do not include the hardfacing layer. These and other advantages may be understood and appreciated as the detailed description proceeds.

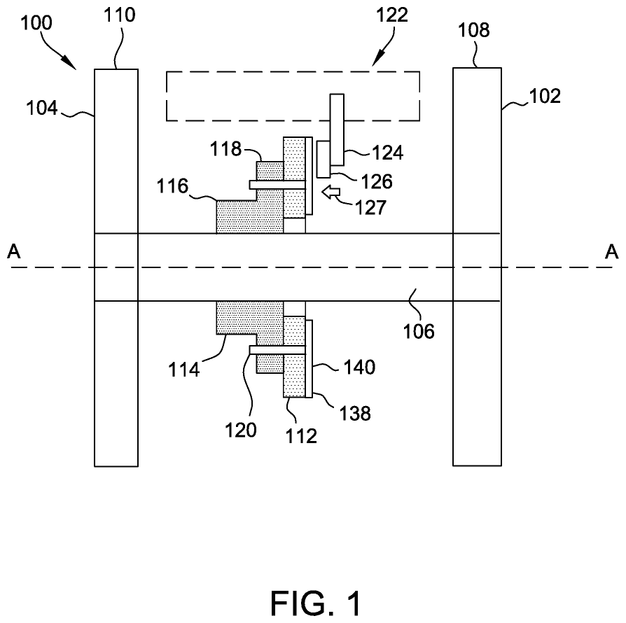

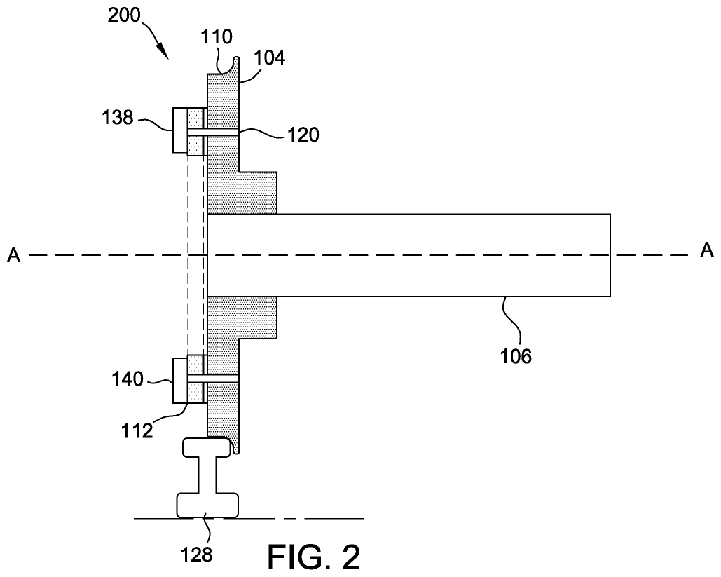

FIG. 1 is a schematic side cross-sectional view of an assembly 100 for a vehicle, such as a rail vehicle. Although a single assembly 100 is shown and described, it should be appreciated that the vehicle may include multiple assemblies 100. For example, a rail vehicle may include two or more assemblies 100, such as four assemblies 100, or eight assemblies 100. The assembly 100 includes a first wheel 102 and a second wheel 104 that are spaced apart and coupled to opposite ends of an axle 106. The axle 106 extends between the first and second wheels 102 and 104 along an axis A and the axle 106 is rotatable about the axis A. Rotation of the axle 106 facilitates rotation of the first and second wheels 102 and 104 about the axis A. The axle 106 and/or the wheels 102 and 104 are attached to a chassis or bogie (not shown) of the vehicle, and rotation of the axle 106 and the wheels 102 and 104 facilitates movement of the vehicle. The axle 106 and/or the wheels 102 and 104 may be rotatably driven by a transmission system (not shown) of the rail vehicle, or may otherwise be rotatably driven by momentum of the vehicle. The first and second wheels 102 and 104 each have a circumferential edge or tread 108 and 110 which engages a track (e.g., a railway track 128 shown in FIG. 2) and enables the vehicle to move along the track.

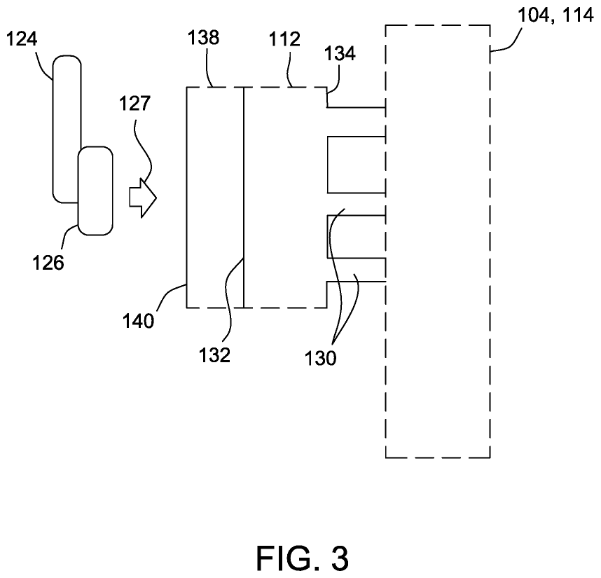

The assembly 100 also includes a brake disc 112 that is mounted on the axle 106 between the wheels 102 and 104. The brake disc 112 has an annular body that defines opposite side surfaces 132 and 134 (shown in FIG. 3). In the assembly 100, the side surfaces 132 and 134 are respectively oriented toward the wheels 102 and 104 when the brake disc 112 is mounted on the axle 106. The brake disc 112 may be mounted on the axle 106 via a hub 114 that extends circumferentially about the axle 106. The hub 114 may be bell-shaped with a tubular section 116 that is press-fitted or friction-fitted onto the axle 106 and the tubular section 116 extends axially relative to the axis A. The tubular section 116 of the hub 114 merges into a flange section 118 that extends radially outward from the tubular section 116 relative to the axis A. The flange section 118 defines an outer surface opposite the tubular section. The outer surface of the flange section 118 mates with one of the side surfaces 134 of the brake disc 112. The brake disc 112 may be attached to the flange section 118 of the hub 114 using fasteners 120, for example. In some embodiments, the brake disc 112 and the hub 114 may be integrally formed. The brake disc 112 and the hub 114 are mounted onto axle 106 and as a result share a common axis of rotation A with the axle 106 and the wheels 102 and 104.

The assembly 100 also includes a braking assembly 122 that facilitates a braking operation of the vehicle. The braking assembly 122 includes an actuator 124 (e.g., a caliper) and one or more brake pads 126 coupled to the actuator 124. The braking assembly 122 may include or be fluidly connected to a pressurized fluid source (not shown). The braking assembly 122 supplies pressurized fluid to the actuator 124 which causes the actuator to move the one or more brake pads 126 against the brake disc 112 in the direction of arrow 127. The one or more brake pads 126 produces a braking force onto the brake disc 112 (i.e., friction is created between the brake pad(s) 126 and the brake disc 112). The friction created reduces the rotational speed of the brake disc 112 and, accordingly, inhibits rotation or reduces rotational speed of the axle 106 and the wheels 102 and 104. In prior art assemblies outside of the present disclosure, the brake pad(s) may directly contact a side surface 132 of the body of the brake disc 112 (i.e., the side surface 132 of the body of the brake disc 112 opposite the side surface 134 that mates with the outer surface of the flange section 118 of the hub 114).

FIG. 2 is a schematic side cross-sectional view of another assembly 200 for a vehicle, such as a rail vehicle. Assembly 200 includes all the features and elements as assembly 100 (shown in FIG. 1). In this embodiment, a brake disc 112 is mounted onto the wheel 104. It should be appreciated, although the brake disc 112 is shown and described as mounted onto the wheel 104, that the brake disc 112 may additionally and/or alternatively be mounted onto the wheel 102 (shown in FIG. 1), in the same way as shown and described. Further, it should be appreciated that assembly 200 may include a brake disc 112 mounted onto the axle 106 via a hub 114 (shown in FIG. 1), or that this feature may be absent from this embodiment. In this embodiment, one of the side surfaces 134 (shown in FIG. 3) of the brake disc 112 mates with an outer surface of the wheel 104 that is oriented opposite of the wheel 102 (shown in FIG. 1). The brake disc 112 is mounted onto (i.e., attached to) the wheel 104 using fasteners 120. When the brake disc 112 is mounted onto the wheel 104, the brake disc 112 and the wheel 104 share a common axis of rotation A. Assembly 200 may also include a braking assembly (e.g., braking assembly 122 shown in FIG. 1) that facilitates a braking operation of the vehicle as described above. In particular, the braking assembly effects a braking force onto the brake disc 112. In prior art assemblies outside of the present disclosure, the brake pad(s) may directly contact a side surface 132 of the body of the brake disc 112 (i.e., the side surface 132 of the body of the brake disc 112 opposite the side surface 134 that mates with the outer surface of the wheel 104).

During a braking operation, heat may be generated in the brake disc 112 due to the friction that is created between the brake pad(s) 126 and the brake disc 112. As shown in FIG. 3, the brake disc 112 may include a plurality of fins 130 that extend between the side surface 134 of the brake disc 112 and the outer surface of the flange section 118 of the hub 114 (in the axle-mounted embodiment shown in FIG. 1) or the outer surface of the wheel 104 (in the wheel-mounted embodiment shown in FIG. 2). The fins 130 define air channels extending between the brake disc 112 and the hub 114 or the wheel 104, which air channels facilitate cooling or heat dispersion during the braking operation.

Additionally, during operation of prior art assemblies, the friction that is created between the side surface 132 of the brake disc 112 and the brake pad(s) 126 causes the brake disc 112 to wear over time. The brake disc 112 is suitably made of a metal material, such as ductile cast iron, cast steel, or forged steel. Such materials are cost-effective and tolerate, to an extent, the higher temperatures and friction forces generated during braking operations. As a result of use of a rail, or other vehicle, material losses from the brake disc 112 (i.e., wear) caused by thermal and friction forces require replacement of the brake disc 112. Replacement of the brake disc 112 results in labor and vehicle down-time costs, as well as material costs for the new brake disc 112.

Generally, the brake disc 112 has a wear limit that is defined as an acceptable amount of material that is lost as a result of the braking operation and which may be measured as a reduced thickness (in mm or inches) of the body of brake disc 112. Once the wear limit is exceeded, replacement of the brake disc 112 is required. The wear limit may be, for example, from about 5 mm to about 15 mm (from about 0.2 inches to about 0.6 inches), or from about 7 mm to about 10 mm (from about 0.28 inches to about 0.39 inches).

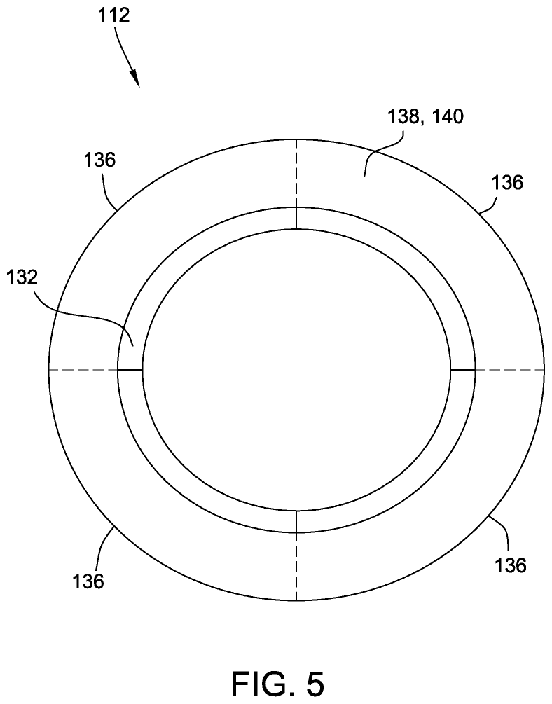

Various approaches may be employed to facilitate reducing costs associated with replacement of the brake disc. For example, in some cases, a segmented brake disc 112 (shown in FIG. 5) may be utilized. The segmented brake disc 112 includes a plurality of arcuate segments 136 that form the brake disc 112.

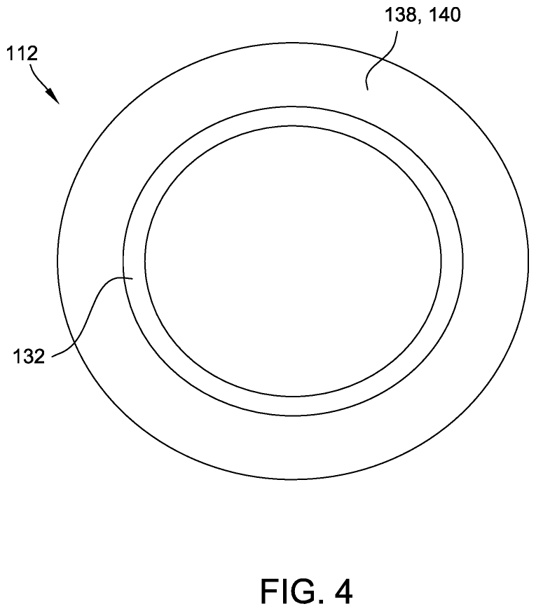

For example, the segmented brake disc 112 may include two or more arcuate segments 136, or four arcuate segments (as is shown in FIG. 5). The arcuate segments 136 may be equally sized. The arcuate segments 136 may be configured to be removed from the brake disc 112 without requiring complete removal of the brake disc 112 or other components of the assembly 100 and/or assembly 200. For example, the arcuate segments 136 may be removed and replaced without removing one or both wheels 102 and 104. This may facilitate reducing vehicle downtime during replacement as compared to situations where a unitary brake disc 112 (shown in FIG. 4) is utilized. However, segmenting the brake disc 112 does not adequately prevent against the issue of wear to facilitate reducing a frequency of replacement of a portion or all of brake disc 112. That is, segmenting the brake disc 112 does not enable for a longer duration of brake disc use before the wear limit of the brake disc 112 is exceeded.

Accordingly, and in accordance with the present disclosure, the brake disc 112 is provided with a hardfacing layer 138 that facilitates increasing a wear resistance of the brake disc 112. The hardfacing layer 138 facilitates increasing the length of time of the period of brake disc use during which the wear limit of the brake disc 112 is not exceeded due to wear caused by the brake pad(s) 126 during a braking operation. The hardfacing layer 138 is deposited onto the side surface 132 of the brake disc 112 and the hardfacing layer 138 defines an externally oriented surface 140 of the brake disc 112. The externally oriented surface 140 defined by the hardfacing layer 138 forms the surface of the brake disc 112 that is contacted by the brake pad(s) 126 during a vehicle braking operation.

Suitably, the hardfacing layer 138 has a layer thickness that is substantially the same as the wear limit of the brake disc 112 without the hardfacing layer 138. For example, the hardfacing layer 138 may have a layer thickness of from about 5 mm to about 15 mm (from about 0.2 inches to about 0.6 inches), or from about 7 mm to about 10 mm (from about 0.28 inches to about 0.39 inches). In various embodiments, the hardfacing layer 138 has a layer thickness of about about 7 mm (about 0.28 inches), about 8 mm (about 0.31 inches), about 9 mm (about 0.35 inches), or about 10 mm (about 0.39 inches).

The hardfacing layer 138 suitably facilitates increasing the useful life of the brake disc 112. The “useful life” of the brake disc is defined as a duration over which the hardfacing layer 138 is worn by the brake pad during the braking operation to reduce the layer thickness of the hardfacing layer to 0 mm.

The body of the brake disc 112 upon which the hardfacing layer 138 is deposited may be unitary or segmented. For example, as shown in FIG. 4, the hardfacing layer 138 may be deposited on the side surface 132 of a unitary body of the brake disc 112. Alternatively, as shown in FIG. 5, the hardfacing layer 138 may be deposited on a segmented body of the body disc 112 that is formed of four, equally spaced arcuate segments 136. Each of the arcuate segments 136 define a side surface that form the side surface 132 of the body of brake disc 112. In other embodiments, the segmented body of the brake disc 112 may be formed of a greater or lesser number of segments (e.g., two or more segments), and the segments may or may not be equally sized. Additionally, although the brake disc 112 illustrated in FIGS. 4 and 5 includes a portion of the side surface 132 of the body of brake disc 112 uncovered by the hardfacing layer 138, it should be appreciated that the hardfacing layer 138 may completely cover the side surface 132, or may cover more or less of the side surface 132 in order to enable the hardfacing layer 138 to function as described herein.

The hardfacing layer 138 suitably forms a smooth, externally oriented surface 140 to facilitate reducing heat generation and/or non-uniform friction during a braking operation when the surface 140 is contacted by the braking pad(s) 126. In some embodiments, the deposition technique used to form hardfacing layer 138 may produce a smooth surface 140. In these embodiments, the initial layer thickness of the deposited hardfacing layer 138 may be the targeted final layer thickness (e.g., from about 5 mm to about 15 mm (from about 0.2 inches to about 0.6 inches), or from about 7 mm to about 10 mm (from about 0.28 inches to about 0.39 inches)). In other embodiments, the deposited hardfacing layer 138 may have an unacceptably rough surface 140. In these other embodiments, the initially deposited hardfacing layer 138 may have a layer thickness that is greater than the targeted layer thickness. For example, in these other embodiments, the initially deposited hardfacing layer 138 may have a layer thickness that is greater than about 20 mm (greater than about 0.79 inches), greater than about 15 mm (greater than about 0.59 inches), greater than about 13 mm (greater than about 0.51 inches), or greater than about 10 mm (greater than about 0.39 inches). In one example, the initially deposited hardfacing layer 138 has a layer thickness between about 10 mm and about 13 mm (between about 0.39 inches and about 0.51 inches). The initially deposited hardfacing layer 138 may be subsequently machined to planarize the externally oriented surface 140 and reduce the layer thickness of the hardfacing layer 138 to the targeted layer thickness (e.g., between about 7 mm and about 10 mm (from about 0.28 inches to about 0.39 inches)). The hardfacing layer 138 may be formed of a material that has a hardness greater than a hardness of the material that forms the annular body of brake disc 112. Increasing the hardness of the surface of the brake disc 112 that is contacted by the brake pad(s) 126 during a breaking operation suitably increases resistance to thermal and friction forces and accordingly increases a wear resistance of the brake disc 112. The hardness of the material may be measured using a Rockwell hardness test and quantified on the Rockwell C hardness scale (denoted as HRC). For example, the materials that form the annular body of brake disc 112 (e.g., ductile cast iron, cast steel, or forged steel) may have a hardness of less than about 30 HRC, such as between about 20 HRC and about 30 HRC, or between about 25 HRC and about 28 HRC. In this regard, the hardfacing layer 138 may be formed of a material that has a hardness greater than about 30 HRC. For example, the material forming the hardfacing layer 138 may have a hardness of from about 30 HRC to about 62 HRC, or from about 40 HRC to about 58 HRC. In various embodiments, the material forming the hardfacing layer 138 has a hardness of from about 51 HRC to about 56 HRC, from about 39 HRC to about 43 HRC, from about 45 HRC to about 50 HRC, from about 53 HRC to about 57 HRC, from about 39 HRC to about 44 HRC, from about 46 HRC to about 52 HRC, from about 50 HRC to about 55 HRC, from about 51 HRC to about 60 HRC, from about 40 HRC to about 50 HRC, from about 52 HRC to about 62 HRC, or from about 40 HRC to about 45 HRC.

The hardfacing layer 138 may be formed of the same or a different material as the material that forms the body of brake disc 112. In embodiments where the hardfacing layer 138 is formed of the same material of the material that forms the body of the brake disc 112, the material forming the hardfacing layer 138 may be subjected to treatment (e.g., during or after deposition of the hardfacing layer 138) to facilitate increasing the hardness of the material that forms the hardfacing layer 138. For example, the material that forms the hardfacing layer 138 may be subjected to quenching to increase the hardness of the material.

When the hardfacing layer 138 is formed of a material that is different from the material that forms the body of brake disc 112, the material that forms that hardfacing layer 138 may be a metallic alloy. Suitably alloys may include cobalt-based alloys, such as Stellite™ alloys or Tribaloy™ alloys manufactured by Kennametal, nickel-based alloys, such as Deloro™ alloys or Tribaloy™ alloys manufactured by Kennametal, and iron-based alloys, such as Delcrome™ alloys manufactured by Kennametal. Additional suitable alloys may include mixtures of carbide particles and nickel-or cobalt-based alloy powders, such as Stelcar™ alloys manufactured by Kennametal. Further suitable metallic alloys may include chromium-alloyed electrodes for hardfacing, such as OK WEARTRODE 30 manufactured by ESAB. Other suitable materials include carbide-metal composites (e.g., tungsten carbide-cobalt or Cr₃Cr₂—NiCr), such as Jet Kote™ carbide-metal powders developed for high velocity oxygen fuel coatings manufactured Kennametal.

Various alloys suitable as the material that forms the hardfacing layer 138 will now be described. It should be appreciated that, in instances where an amount of a component of an example alloy is given in percent (%) by weight, this is relative to a total weight of the alloy composition unless stated otherwise.

In examples where the hardfacing layer 138 is formed of a cobalt-based alloy, the cobalt-based alloy may include at least one of chromium, carbon, tungsten, molybdenum, boron, nickel, niobium, iron, silicon, and vanadium.

In some embodiments, the cobalt-based alloy that forms the hardfacing layer 138 includes carbon, chromium, and tungsten. In one example, the cobalt-based alloy includes from about 0.1% by weight to about 5% by weight carbon, from about 25% by weight to about 35% by weight chromium, and about 1% by weight to about 20% by weight tungsten. In another example, the cobalt-based alloy includes from about 2.4% by weight to about 2.5% by weight carbon, from about 31% by weight to about 32% by weight chromium, and from about 12% by weight to about 13% by weight tungsten. In another example, the cobalt-based alloy includes from about 1% by weight to about 1.2% by weight carbon, from about 27% by weight to about 30% by weight chromium, and from about 4% by weight to about 5% by weight tungsten. In yet another example, the cobalt-based alloy includes about 0.4% by weight carbon, about 26% by weight chromium, and about 5.5% by weight tungsten. In still another example, the cobalt-based alloy includes from about 1.5% by weight to about 1.8% by weight carbon, about 30% by weight chromium, and from about 8% by weight to about 9% by weight tungsten. In yet another example, the cobalt-based alloy includes from about 2.4% by weight to about 2.5% by weight carbon, from about 32% by weight to about 33% by weight chromium, and from about 16% by weight to about 17% by weight tungsten.

In some embodiments, the cobalt-based alloy that forms the hardfacing layer 138 includes carbon, chromium, and molybdenum. In one example, the cobalt-based alloy includes about 0.2% by weight carbon, about 27% by weight chromium, and about 5% by weight molybdenum. In another example, cobalt-based alloy includes about 1.2% by weight carbon, about 31% by weight chromium, and about 4% by weight molybdenum. In another example, the cobalt-based alloy includes from about 1.5% by weight to about 1.6% by weight carbon, from about 30% by weight to about 31% by weight chromium, and about 8% by weight molybdenum.

In some embodiments, the cobalt-based alloy that forms the hardfacing layer 138 includes carbon, chromium, tungsten, and nickel. In one example, the cobalt-based alloy includes about 0.5% by weight carbon, about 26% by weight chromium, about 7% by weight tungsten, and about 10% by weight nickel. In another example, the cobalt-based alloy includes about 1.7% by weight carbon, from about 25% by weight to about 26% by weight chromium, about 12% by weight tungsten, and about 22% by weight nickel. In another example, the cobalt-based alloy includes about 0.1% by weight carbon, about 20% by weight chromium, about 14% by weight tungsten, and about 10% by weight nickel.

In some embodiments, the cobalt-based alloy that forms the hardfacing layer 138 includes chromium, tungsten, and boron. In one example, the cobalt-based alloy includes about 22% by weight chromium, about 4.5% by weight tungsten, and about 2.4% by weight boron.

In some embodiments, the cobalt-based alloy that forms the hardfacing layer 138 includes chromium, tungsten, nickel, niobium, iron, and carbon. In one example, the cobalt-based alloy includes about 25% by weight chromium, about 2% by weight tungsten, about 6% by weight nickel, about 5% by weight niobium, about 4% by weight iron, and about 0.4% by weight carbon.

In some embodiments, the cobalt-based alloy that forms the hardfacing layer 138 includes carbon, chromium, tungsten, nickel, and vanadium. In one example, the cobalt-based alloy includes about 1% by weight carbon, about 28% by weight chromium, about 19% by weight tungsten, about 5% by weight nickel, and about 1% by weight vanadium.

In some embodiments, the cobalt-based alloy that forms the hardfacing layer 138 includes carbon, chromium, nickel, and molybdenum. In one example, the cobalt-based alloy includes from about 0.1% by weight to about 0.25% by weight carbon, from about 26% by weight to about 28% by weight chromium, from about 3% by weight to about 4% by weight nickel, and from about 5.2% by weight to about 6.0% by weight molybdenum.

In some embodiments, the cobalt-based alloy that forms the hardfacing layer 138 includes chromium, tungsten, carbon, nickel, molybdenum, and iron. In one example, the cobalt-based alloy includes about 26% by weight chromium, about 2% by weight tungsten, about 0.06% by weight carbon, about 9% by weight nickel, about 5% by weight molybdenum, and about 3% by weight iron.

In some embodiments, the cobalt-based alloy that forms the hardfacing layer 138 includes tungsten carbide particles.

In some embodiments, the cobalt-based alloy that forms the hardfacing layer 138 includes chromium, molybdenum, and silicon. In one example, the cobalt-based alloy includes about 8.5% by weight chromium, 28% by weight molybdenum, and 2.5% by weight silicon. In another example, the cobalt-based alloy includes about 14% by weight chromium, 27% by weight molybdenum, and 2.6% by weight silicon. In another example, the cobalt-based alloy includes about 18% by weight chromium, 28% by weight molybdenum, and 3.4% by weight silicon.

In some embodiments, the cobalt-based alloy that forms the hardfacing layer 138 includes chromium, nickel, molybdenum, and silicon. In one example, the cobalt-based alloy includes about 18% by weight chromium, 16% by weight nickel, 22% by weight molybdenum, and 3.4% by weight silicon.

In examples where the hardfacing layer 138 is formed of a nickel-based alloy, the nickel-based alloy may include at least one of chromium, carbon, molybdenum, boron, iron, silicon, copper, vanadium, and manganese.

In some embodiments, the nickel-based alloy that forms the hardfacing layer 138 includes carbon, iron, silicon, boron, and copper. In one example, the nickel-based alloy includes about 0.05% by weight carbon, about 1% by weight iron, about 2% by weight silicon, about 1% by weight boron, and about 20% by weight copper.

In some embodiments, the nickel-based alloy that forms the hardfacing layer 138 includes carbon, iron, silicon, and boron. In one example, the nickel-based alloy includes about 0.05% by weight carbon, from about 0.5% by weight to about 0.8% by weight iron, from about 2.5% by weight to about 3% by weight silicon, and from about 1.4% by weight to about 2.1% by weight boron.

In some embodiments, the nickel-based alloy that forms the hardfacing layer 138 includes carbon, chromium, silicon, and boron. In one example, the nickel-based alloy includes about 0.15% by weight carbon, about 5% by weight chromium, about 3.2% by weight silicon, and about 1.5% by weight boron. In another example, the nickel-based alloy includes about 0.25% by weight carbon, about 7.5% by weight chromium, about 3.5% by weight silicon, and about 1.7% by weight boron. In another example, the nickel-based alloy includes about 0.45% by weight carbon, about 11% by weight chromium, about 3.9% by weight silicon, and about 2.3% by weight boron. In yet another example, the nickel-based alloy include about 0.75% by weight carbon, about 15% by weight chromium, about 4.4% by weight silicon, and about 3.2% by weight boron.

In some embodiments, the nickel-based alloy that forms the hardfacing layer 138 includes copper and manganese. In one example, the nickel-based alloy includes about 22% by weight copper and about 2% by weight manganese.

In some embodiments, the nickel-based alloy that forms the hardfacing layer 138 includes carbon, chromium, iron, silicon, and boron. In one example, the nickel-based alloy includes about 0.4% by weight carbon, about 12% by weight chromium, from about 2% by weight to about 3% by weight iron, about 2.9% by weight silicon, and about 1.6% by weight boron. In another example, the nickel-based alloy includes about 0.5% by weight carbon, about 12% by weight chromium, from about 3% by weight to about 5% by weight iron, about 3.5% by weight silicon, and about 2.2% by weight boron. In another example, the nickel-based alloy includes about 0.6% by weight carbon, about 12% by weight chromium, from about 3% by weight to about 5% by weight iron, about 4.0% by weight silicon, and about 2.3% by weight boron. In yet another example, the nickel-based alloy includes about 0.7% by weight carbon, about 13% by weight chromium, from about 3% by weight to about 5% by weight iron, about 4.3% by weight silicon, and about 3.0% by weight boron.

In still a further example, the nickel-based alloy includes from about 0.2% by weight to about 0.7% by weight carbon, from about 7.5% by weight to about 15% by weight chromium, from about 2.3% by weight to about 4% by weight iron, from about 3.2% by weight to about 4.4% by weight silicon, and from about 1.2% by weight to about 3.1% by weight boron.

In some embodiments, the nickel-based alloy that forms the hardfacing layer 138 includes chromium, molybdenum, and silicon. In one example, the nickel-based alloy includes about 16% by weight chromium, about 32% by weight molybdenum, and about 3.4% by weight silicon.

In some embodiments, the nickel-based alloy that forms the hardfacing layer 138 includes carbon, silicon, and boron. In one example, the nickel-based alloy includes about 0.05% by weight carbon, about 3.7% by weight silicon, and about 1.9% by weight boron.

In some embodiments, the nickel-based alloy that forms the hardfacing layer 138 includes carbon, chromium, molybdenum, and silicon. In one example, the nickel-based alloy includes about 0.08% by weight carbon, about 16% by weight chromium, about 32% by weight molybdenum, and about 3.4% by weight silicon.

In some embodiments, the nickel-based alloy that forms the hardfacing layer 138 includes tungsten carbide particles.

In examples where the hardfacing layer 138 is formed of an iron-based alloy, the iron-based alloy may include at least one of chromium, carbon, nickel, molybdenum, silicon, and manganese.

In some embodiments, the iron-based alloy that forms the hardfacing layer 138 includes chromium, carbon, and manganese. In one example, the iron-based alloy includes about 27% by weight chromium, about 2.9% by weight carbon, and about 0.5% by weight manganese.

In some embodiments, the iron-based alloy that forms the hardfacing layer 138 includes carbon and molybdenum. In one example, the iron-based alloy includes about 3.8% by weight carbon and about 10% by weight molybdenum.

In some embodiments, the iron-based alloy that forms the hardfacing layer 138 includes chromium, carbon, nickel, molybdenum, silicon, and manganese. In one example, the iron-based alloy includes about 28% by weight chromium, about 1.9% by weight carbon, about 16.5% by weight nickel, about 4.5% by weight molybdenum, about 1.3% by weight silicon, and about 0.8% by weight manganese. In another example, the iron-based alloy includes about 17% by weight chromium, about 0.05% by weight carbon, about 11% by weight nickel, about 2.6% by weight molybdenum, about 2.5% by weight silicon, and about 0.4% by weight manganese. In another example, the iron-based alloy includes about 18% by weight chromium, less than about 0.03% by weight carbon, about 13% by weight nickel, about 2.6% by weight molybdenum, about 1.8% by weight silicon, and about 0.7% by weight manganese.

In some embodiments, the iron-based alloy that forms the hardfacing layer 138 includes chromium, carbon, nickel, molybdenum, and silicon. In one example, the iron-based alloy includes about 25% by weight chromium, about 2.5% by weight carbon, about 14% by weight nickel, about 7% by weight molybdenum, and about 1.8% by weight silicon.

Suitable methods for forming the hardfacing layer 138 from the above-described materials will now be described.

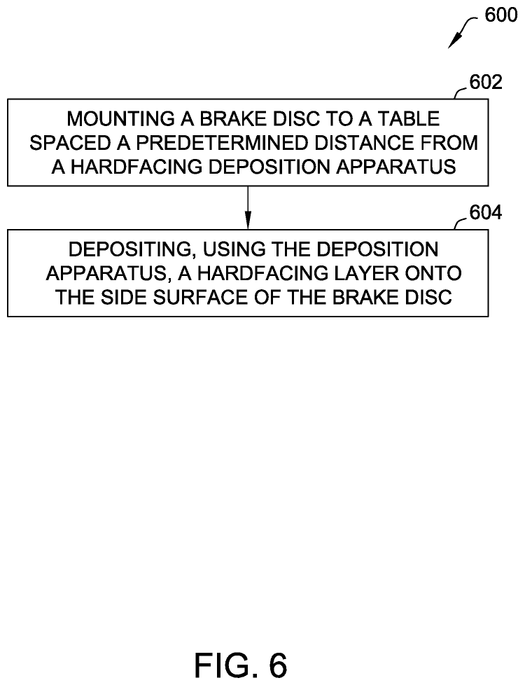

Referring to FIG. 6, an example flow chart illustrating a general method 600 for forming a brake disc 112 having a hardfacing layer 138 is shown.

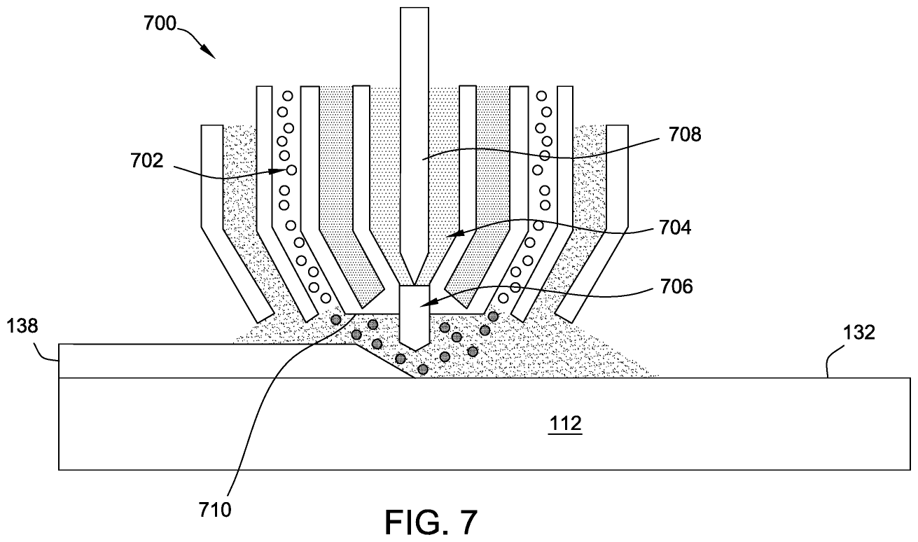

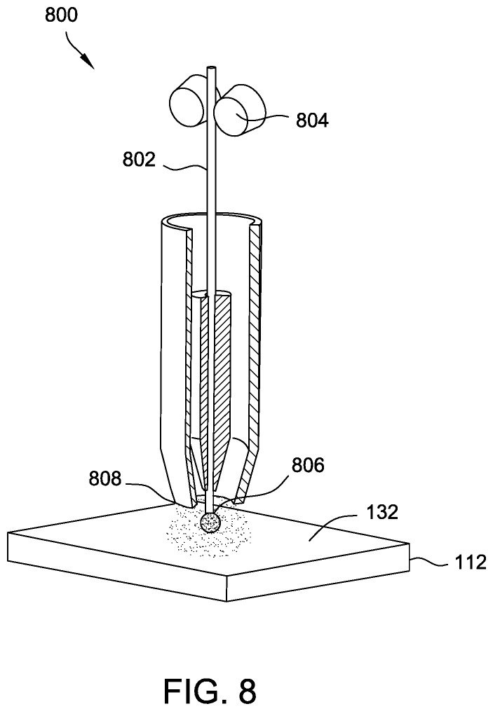

The method 600 includes, at 602, mounting a brake disc 112 to a table (not shown) spaced a predetermined distance from a hardfacing deposition apparatus (e.g., a plasma transferred arc apparatus 700 shown in FIG. 7 or an arc welding machine 800 shown in FIG. 8). The brake disc 112 includes a body formed of a first material (e.g., ductile cast iron, cast steel, or forged steel). The brake disc 112 is mounted so that a side surface 132 upon which the hardfacing layer 138 is to be deposited is oriented away from the table toward the deposition apparatus.

The method continues, at 604, with depositing, using the deposition apparatus, a hardfacing layer 138 onto the side surface 132 of the brake disc 112. The hardfacing layer 138 is formed of a second material that has a hardness greater than the first material that forms the body of the brake disc 112. The deposited hardfacing layer 138 defines an externally oriented surface 140 that is configured to be contacted, for example, by braking pad(s) 126, during a braking operation to facilitate braking of a vehicle. Accordingly, in some embodiments, the method 600 may include attaching the brake disc 112 having the hardfacing layer 138 to a rail vehicle wheel (e.g., one or both of wheels 102 and 104) or a rail vehicle axle (e.g., axle 106).

Referring to FIG. 7, in one embodiment, the deposition apparatus is a plasma transferred arc (PTA) welding apparatus 700. The PTA apparatus 700 is configured to heat and excite a stream of plasma gas 704 by an electric arc 706 formed by an electrode 708. The electrode 708 may be made of tungsten, for example. The flow of plasma gas 704 and the electric arc 706 are constricted and transferred out of the apparatus 700 through a nozzle 710. This generates a stream of intense heat or a “torch” that is directed to a target region on a substrate (e.g., the side surface 132 of the brake disc 112). A metallic alloy powder feedstock 702 is injected into the PTA apparatus 700 (e.g., via a powder injector (not shown)). The injected powder 702 may be, for example, a cobalt-based alloy powder or a nickel-based alloy powder. The powder 702 is exposed to the torch and the powder 702 is melted, fused, and deposited onto the brake disc 112 substrate to form the hardfacing layer 138.

Suitably, the power level of the PTA apparatus 700 is configured so that the injected powder 702 is melted, and optionally an outermost portion of the side surface 132 of the brake disc 112 is melted, but the bulk portion of the brake disc 112 substrate is not melted. The injected powder 702 is progressively melted, deposited, and allowed to solidify as the hardfacing layer 138.

Referring to FIG. 8, in another embodiment, the deposition apparatus is an arc welding machine 800 that is configured to deposit the hardfacing layer 138 from a cored welding wire feed 802. Examples of arc welding machine 800 include a gas metal arc welding (GMAW) apparatus, a metal inert gas (MIG) apparatus, a metal active gas (MAG) apparatus, and a submerged arc welding (SAW) apparatus. The cored welding wire feed 802 is continuously injected from a spool (not shown) via a wire-feed mechanism 804 into the machine 800. An arc 806 is formed at a nozzle 808 of the machine 800. The wire feed 802 is fed out through the nozzle 808 where it meets the arc 806. The wire feed 802 is melted by the arc 806 and the melted wire feed 802 is deposited onto the side surface 132 of the brake disc 112 to form the hardfacing layer 138.

In yet another embodiment, the deposition apparatus may be a shielded metal arc welding (SMAW) apparatus (not shown). In this embodiment, a hardfacing electrode is fed to the SMAW apparatus. The SMAW apparatus then deposits the hardfacing layer 138 onto the side surface 132 of the brake disc 112 from the hardfacing electrode feed.

Referring to FIG. 6, during depositing 604, a torch or nozzle of the deposition apparatus (e.g., the nozzle 710 of PTA apparatus 700 or the nozzle 808 of the machine 800) is brought to a predetermined distance from the side surface 132 of the brake disc 112. The deposition apparatus is set, optionally with predetermined settings, to generate a suitable arc to melt the material (e.g., powder feedstock 702, cored welding wire feed 802, or hardfacing electrode feed) used to form the hardfacing layer 138. Depositing 604 is performed by progressively depositing “circles” of the hardfacing layer 138 extending circumferentially along the side surface 132 of the brake disc 112. The hardfacing layer 138 may be deposited either starting from the outer periphery of the side surface 132 or the inner periphery of the side surface 132. The table (not shown) is rotated at a suitable speed (RPM) to ensure deposition is even circumferentially. Once each circumferentially deposited layer is completed, the table is moved a predetermined distance so that a subsequent layer is deposited. Suitably, each successive circumferentially deposited layer minimally overlaps a preceding layer to facilitate achieving targeted, uniform thickness of the hardfacing layer 138. The successive deposition of circumferentially extending layers continues until the entire side surface 132, or a targeted portion of the side surface 132, is covered with the hardfacing layer 138. Depositing 604 may be repeated if the layer thickness of the hardfacing layer 138 is below a targeted thickness. After completion of depositing 604, and the hardfacing layer 138 has the targeted thickness, the brake disc 112 is allowed to cool. Optionally, the hardfacing layer 138 may be subsequently machined to planarized the externally oriented surface 140 and/or to reduce the layer thickness of the hardfacing layer 138.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and clauses, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and clauses, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods.

1. A brake disc comprising:
a brake disc body having a side surface, wherein the brake disc body is formed of a first material having a first hardness, and
a hardfacing layer deposited onto the side surface of the brake disc body, wherein the hardfacing layer is formed of a second material having a second hardness, the second hardness being greater than the first hardness, and wherein the hardfacing layer defines an externally oriented surface of the brake disc that is configured to be contacted by a brake pad for a vehicle braking operation.

2-7. (canceled)

8. The brake disc of claim 1, wherein the second material is a cobalt-based alloy.

9. The brake disc of claim 8, wherein the second material is a cobalt-based alloy comprising at least one of chromium, carbon, tungsten, molybdenum, boron, nickel, niobium, iron, silicon, and yanadium.

10. The brake disc of claim 8, wherein the second material is a cobalt-based alloy comprising carbon, chromium, and tungsten.

11. The brake disc of claim 10, wherein the cobalt-based alloy comprises from about 0.1 % by weight to about 5% by weight carbon, from about 25% by weight to about 35% by weight chromium, and about 1 % by weight to about 20% by weight tungsten.

12. The brake disc of claim 10, wherein the cobalt-based alloy comprises from about 2.4% by weight to about 2.5% by weight carbon, from about 31 % by weight to about 32% by weight chromium, and from about 12% by weight to about 13 % by weight tungsten.

13. The brake disc of claim 10, wherein the cobalt-based alloy comprises from about 1 % by weight to about 1.2% by weight carbon, from about 27% by weight to about 30% by weight chromium, and from about 4% by weight to about 5% by weight tungsten.

14. The brake disc of claim 10, wherein the cobalt-based alloy comprises about 0.4% by weight carbon, about 26% by weight chromium, and about 5.5% by weight tungsten.

15. The brake disc of claim 10, wherein the cobalt-based alloy comprises from about 1.5% by weight to about 1.8% by weight carbon, about 30% by weight chromium, and from about 8% by weight to about 9% by weight tungsten.

16. The brake disc of claim 10, wherein the cobalt-based alloy comprises from about 2.4% by weight to about 2.5% by weight carbon, from about 32% by weight to about 33% by weight chromium, and from about 16% by weight to about 1 7% by weight tungsten.

17. The brake disc of claim 8, wherein the cobalt-based alloy comprises carbon, chromium, and molybdenum.

18. The brake disc of claim 17, wherein the cobalt-based alloy comprises about 0.2% by weight carbon, about 27% by weight chromium, and about 5% by weight molybdenum.

19. The brake disc of claim 17, wherein the cobalt-based alloy comprises about 1.2% by weight carbon, about 31 % by weight chromium, and about 4% by weight molybdenum.

20. The brake disc of claim 17, wherein the cobalt-based alloy comprises from about 1.5% by weight to about 1.6% by weight carbon, from about 30% by weight to about 31 % by weight chromium, and about 8% by weight molybdenum.

21. The brake disc of claim 8, wherein the second material is a cobalt-based alloy comprising carbon, chromium, tungsten, and nickel.

22. The brake disc of claim 21, wherein the cobalt-based alloy comprises about 0.5% by weight carbon, about 26% by weight chromium, about 7% by weight tungsten, and about 10% by weight nickel.

23. The brake disc of claim 21, wherein the cobalt-based alloy comprises about 1. 7% by weight carbon, from about 25% by weight to about 26% by weight chromium, about 12% by weight tungsten, and about 22% by \\eight nickel.

24. The brake disc of claim 21, wherein the cobalt-based alloy comprises about 0.1 % by weight carbon, about 20% by weight chromium, about 14% by weight tungsten, and about 10% by weight nickel.

25. The brake disc of claim 8, wherein the second material is a cobalt-based alloy comprising chromium, tungsten, and boron.

26. The brake disc of claim 25, wherein the cobalt-based alloy comprises about 22% by weight chromium, about 4.5% by weight tungsten, and about 2.4% by weight boron.

27-121. (canceled)
